(19) United States
(12) Patent Application Publication
(10) Pub. No.: US 2023/0298035 A1
(43) Pub. Date: Sep. 21, 2023

(54) Completing a Transaction

(71) Applicant: Mastercard International Incorporated, New York, NY (US)

(72) Inventors: Valerie Wouters, Genval (BE); Cristian Radu, Beauvechain (BE); Claire Venot, Rambouillet (FR)

(21) Appl. No.: 17/699,838

(22) Filed: Mar. 21, 2022

(51) Int. Cl. G06Q 20/40; G06Q 20/36

(52) U.S. Cl. CPC G06Q 20/405; G06Q 20/3674

(57) ABSTRACT

The present invention relates to a computer implemented method (10) of completing a transaction. The method (10) comprises: providing (1) a consent start date from a consumer, providing (2) a consent end date from the consumer, requesting (3) authorisation to complete the transaction on a specified date, and providing (4) authorisation to complete the transaction if the specified date is the same as or later than the consent start date and the same as or earlier than the consent end date. Also disclosed is a system (30) for completing a transaction. The system (30) comprises a payment system (31), a merchant system (32) and an issuer system (33). The payment system (31) is configured to provide a consent start date from a consumer and a consent end date from the consumer. The merchant system (32) is configured to request authorisation to complete the transaction on a specified date. The issuer system (33) is configured to provide authorisation to complete the transaction if the specified date is after the consent start date and before the consent end date.

### TECHNICAL FIELD

The present invention relates to a computer implemented method of completing a transaction and a system for completing a transaction.

### BACKGROUND

In order to complete an action between a consumer and a merchant, for example a payment transaction, consent from the consumer may be required in advance of the action. In some situations, a merchant may require consent from a consumer to complete an action but the consumer may not be available at the time of the action to provide consent. In other situations, a consumer may wish to provide consent for a future action, for example when a total payment due to a merchant is to be paid in multiple instalments. A first proportion of the total payment may be required in a first payment transaction on a first date, followed by the remainder of the total payment in a second payment transaction on a second date. In this example, the consumer may be required to provide consent for the first and second payment transactions separately.

Another example of an action which may require consent in advance from a consumer is an exchange of data. As well as obtaining consent to complete a payment transaction, it may also be desirable for a merchant to access data relating to a consumer that is hosted by an issuer of the payment device. An example of such data is an age of a consumer, which the merchant may be required to verify before providing age restricted goods, such as alcohol, to the consumer. An exchange of such data from the issuer to the merchant may require the consumer's consent. The merchant may require this data at some unknown time in the future when the consumer may not be available to provide consent. In another example, a third party Open Banking application developer may wish to access transaction data hosted by a payment network, for example the Mastercard® payment network. Access of such data may require the consent of a consumer.

Another example of an action which may require consent in advance from a consumer is an update to terms and conditions of use of a product or service, such as software or a rental agreement, used by the consumer.

Sending a digital request for consent to a consumer and subsequently sending a digital confirmation of the consent to a merchant both utilise computing and network resources. Each request and confirmation has an associated cost and hardware consumption. It is therefore desirable to reduce the number of requests and confirmations sent in order to complete a given action.

Having to consent to completion of an action on multiple occasions may cause inconvenience for a consumer. This may also cause inconvenience for the merchant, as the user may not be available to provide consent when the merchant wishes to complete the action.

### SUMMARY OF THE INVENTION

An aspect of the invention provides a computer implemented method of completing a transaction. The method comprises: providing a consent start date from a consumer, providing a consent end date from the consumer, requesting authorisation to complete the transaction on a specified date, and providing authorisation to complete the transaction if the specified date is the same as or later than the consent start date and the same as or earlier than the consent end date.

A consent start date is a date from which the consumer consents to completing the transaction. A consent end date is a date after which the consumer does not consent to completing the transaction.

The method may comprise generating a cryptogram comprising the consent start date and the consent end date. The method may comprise generating a cryptogram based on the date and/or time the consent start date and/or the consent end date is provided from the consumer. The or each cryptogram may form part of authentication data for communication in a 3D-Secure protocol. The or each cryptogram may form part of a transaction authorisation message or a financial request message. The or each cryptogram may form part of data, such as chip data, in a transaction authorisation message of a financial transaction request message. The or each cryptogram may be generated by a digital wallet or a payment device.

The method may comprise digitally signing the consent start date and the consent end date. The method may also comprise digitally signing the date and/or time when consumer has provided a consent start date and/or a consent end date.

The method may comprise providing a consent start date and a consent end date for multiple transactions.

The transaction may comprise a payment transaction, e.g. an exchange of monetary funds. The transaction may comprise an exchange of data, i.e. a data transaction. The exchange of data may comprise an exchange of personal data relating to the consumer. The exchange of data may comprise an exchange of payment data relating to the consumer.

The transaction may be initiated by the consumer. The transaction may be initiated by a merchant.

The method may comprise providing a payment token or payment data. The method may comprise authenticating the consent start date and/or the consent end date using the payment token or payment data. To avoid consumer repudiation, the method may comprise authenticating the date and time when the consumer is providing the consent.

Another aspect of the invention provides a system for completing a transaction. The system comprises a payment system, a merchant system and an issuer system. The payment system is configured to provide a consent start date from a consumer and a consent end date from the consumer. The merchant system is configured to request authorisation to complete the transaction on a specified date. The issuer system is configured to provide authorisation to complete the transaction if the specified date is after the consent start date and before the consent end date.

The system may comprise a payment network in communication with the merchant system and the issuer system. The payment system may comprise a portable communications device comprising a digital device wallet. The system may comprise a digital wallet in communication with the merchant system. The system may comprise a token service provider.

Another aspect of the invention provides a method of providing consent from a consumer to complete an action. The method comprises: providing a consent start date from a consumer; providing a consent end date from the consumer; and completing the action on a specified date if the specified date is after the consent start date and before the consent end date.

The action may comprise: a payment transaction, an exchange of data, and/or an update to terms and conditions of use or a service agreement. The action may comprise any action which requires consent from a consumer to complete.

The method may comprise providing the consent start date and/or the consent end date using a portable communications device. The method may comprise providing a payment token. The payment token may be stored on the portable communications device. The method may comprise authenticating the consent start date and/or the consent end date using the payment token.

The method may comprise providing the consent start date and/or providing the consent end date using a point-of-sale device. The method may comprise providing payment data. The payment data may be associated with a physical card. The method may comprise authenticating the consent start date and/or the consent end date using the payment data.

Authenticating the consent start date and/or the consent end date may comprise verifying that the consent start date and/or the consent end date was provided by the consumer and not another party.

The term ‘digital wallet’ as used herein refers to a system comprising electronic components (such as one or more processors, memory devices, or servers) suitable for storing information used to complete actions. Such information may comprise actual payment credentials, tokenised payment credentials, and information relating to a specific action. The information stored by a digital wallet may be stored in an encrypted form.

The term ‘payment network’ as used herein refers to a network of electronic components (such as one or more processors, memory devices, or servers) suitable for communicating between systems, such as systems hosted by different financial institutions, to complete actions. An example of a payment network is the Mastercard® payment network.

The term ‘token service provider’ as used herein refers to an entity which hosts a system comprising electronic components (such as one or more processors, memory devices, or servers) suitable for protecting information used to complete actions. A token service provider may use the process of tokenisation to replace payment credentials, for example a primary account number (PAN), belonging to a consumer with other information referred to as a ‘token’. A token service provider may be capable of encrypting and decrypting information used in the completion of an action.

### BRIEF DESCRIPTION OF THE DRAWINGS

FIG. 1 shows a method of completing a transaction according to an embodiment;

FIG. 2 shows a method of completing a transaction according to another embodiment;

FIG. 3 shows a system for completing a transaction according to an embodiment;

FIG. 4 shows a system for completing a transaction according to another embodiment; and

FIG. 5 shows a system for completing a transaction according to another embodiment.

### DETAILED DESCRIPTION

Embodiments of the invention will now be described, by way of example only, with reference to the accompanying drawings.

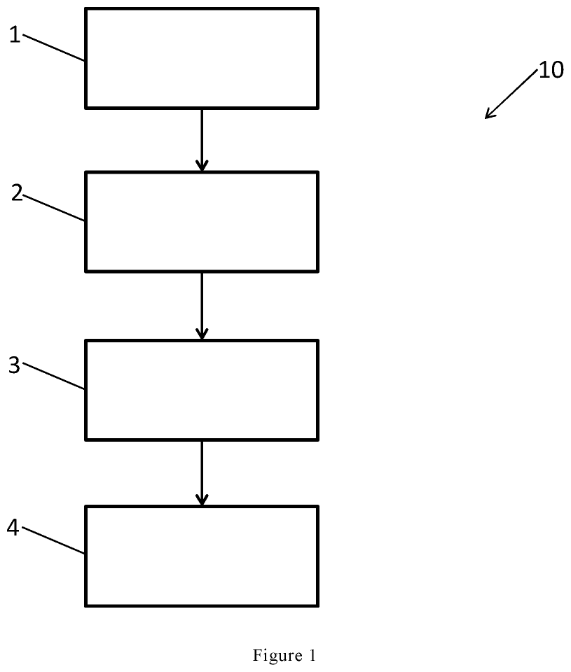

FIG. 1 shows a method 10 of completing a transaction according to an embodiment. The method comprises providing a consent start date from a consumer at step 1, providing a consent end date from the consumer at step 2, requesting authorisation to complete the transaction on a specified date at step 3, and providing authorisation to complete the transaction if the specified date is the same as or later than the consent start date and the same as or earlier than the consent end date at step 4.

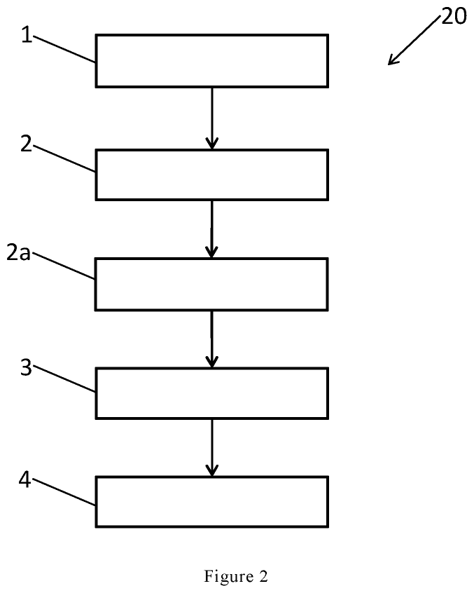

FIG. 2 shows a method 20 of completing a transaction according to another embodiment. The method 20 may be used in any of the use cases described above. The method 20 comprises the same steps 1-4 of method 10. The method 20 additionally comprises generating a cryptogram based on the consent start date and the consent end date at step 2a. The cryptogram may comprise a digital signature. At step 2a, the method may comprise digitally signing the consent start date and consent end date using a private key. Generating a cryptogram based on the consent start date and the consent end date may improve the security of the transaction, and may help to prevent the consent start date and the consent end date being maliciously modified.

In some embodiments, the method may comprise generating a cryptogram based on the date and/or time the consent start date and/or the consent end date is provided from the consumer. The cryptogram may comprise a digital signature. The method may comprise digitally signing the date and/or time the consent start date and/or the consent end date is provided from the consumer using a private key.

In some embodiments, the invention may provide a method of providing consent from a consumer to complete an action other than a payment transaction or a data transaction. For example, the invention may provide a method of providing consent from a consumer to an update to terms and conditions of use of a product or service, or an update to a service agreement. In such embodiments, the method may comprise: providing a consent start date from a consumer; providing a consent end date from the consumer; and completing the action on a specified date if the specified date is after the consent start date and before the consent end date. The method may or may not comprise requesting authorisation to complete the action on the specified date. The method may or may not comprise generating a cryptogram based on the consent start date and the consent end date.

In some examples, the cryptogram may form part of authentication data communicated using a Universal Cardholder Authentication Field™ (UCAF) in a 3D-Secure protocol. For example, the cryptogram may form part of an Accountholder Authentication Value (AAV) used in the Mastercard™ SecureCode™ protocol. In other examples, the cryptogram may form part of chip validation data that may be communicated during a transaction authorisation.

Providing the consent start date and providing the consent end date in any method of the invention may be carried out in separate steps on the same day or on different days. The consent start date and the consent end date may be the same. The consent start date and/or the consent end date may be a future date.

Providing the consent start date and providing the consent end date in any method of the invention may be carried out in a single step. For example, the consent end date may be explicitly requested, e.g. in the format ‘Please provide a consent end date’ or similar, on a given date. By providing a consent end date on the given date, the user will also be providing a consent start date of the given date. The consent start date may therefore not be explicitly requested, e.g. in the format ‘Please provide a consent start date’ or similar. The consent start date may be implicitly provided by providing consent from the user on a given date or by providing the consent end date on a given date.

Providing the consent start date in any method of the invention may comprise requesting consent from the user on a given date, e.g. by asking the user ‘Do you consent: yes or no?’. The given date may be a date on which the transaction is initiated, or a date on which notification of the transaction is sent to the consumer. A user providing consent, e.g. answering ‘yes’, on a given date may be equivalent to the user providing a consent start date which is the given date. Alternatively, the consent start date may be explicitly requested, e.g. in the format ‘Please provide a consent start date’ or similar. The user may then provide a consent start date, for example a date on or after the date on which the consent start date is requested. The consent provided by a user may be digitally timestamped with the given date to indicate the consent start date.

Authorisation to complete the transaction in either method 10, 20 may be requested on a given date. The given date may be a date on which the transaction is initiated, or the given date may be any date after the date on which the transaction is initiated. The date specified for completing the transaction may be the given date, for example authorisation to complete the transaction may be requested on the same day that completion of the transaction is required. In other examples, the date specified for completing the transaction may be a date in the future, i.e. authorisation to complete the transaction may be requested for a date in the future.

If a request for consent is sent to a consumer on a given date after initiation of a transaction and before the transaction is required to be completed, or on a given date before an action is required to be completed, there is a risk that the consumer will not be able to provide consent on the given date. For example, if consent is to be provided by means of a mobile telephone using a mobile banking application, the consumer may not have access to a mobile telephone on the given date. This may result in multiple requests for consent needing to be sent to the consumer before consent is provided. Each request for consent may have an associated hardware, computational and/or network cost. Providing a consent start date and a consent end date on initiation of a transaction avoids the need to send multiple requests for consent, thereby enabling more efficient use of hardware, computational and/or network resources.

In an example use case of either of the methods 10, 20, the method 10, 20 is used to complete a payment transaction. The consumer may wish to purchase goods from a merchant and the merchant may promise delivery of the goods before a given date. The merchant may be restricted, by law or otherwise, to receiving payment for the goods upon or after delivery of the goods. The consumer may not wish to pay for the goods if they are delivered after the promised date. The method 10, 20 may begin by providing a consent start date and a consent end date from the consumer, for example by explicitly providing a consent end date on the date the transaction is initiated and thereby also implicitly providing a consent start date. The consumer may provide a consent end date preceding the delivery date promised by the merchant. The consumer may provide a consent end date which incorporates a reasonable delivery period before the promised delivery date, for example a few days. Alternatively, the consumer may provide a consent end date on or after the promised delivery date, for example to allow for delays in a delivery process.

After the consent start and end dates have been provided, the merchant may request authorisation to complete the transaction on a specified date. For example, the merchant may request authorisation for the date of dispatch of the goods to the consumer. If the date of dispatch is after the consent start date and before the consent end date, the authorisation to complete the transaction will be provided. If authorisation is requested after the consent end date, authorisation to complete the transaction may not be provided.

In some embodiments, the method 10, 20 may comprise completing multiple payment transactions. The method 10, 20 may comprise providing a consent start date and a consent end date for each of the transactions. The method 10, 20 may comprise requesting authorisation to complete each of the transactions. In an example use case, a consumer may be able to pay for goods or services in instalments. For example, a consumer may be able to pay a deposit upon or shortly after initiation of a transaction, and pay the remainder of the payment upon or shortly before delivery of the goods or services. In this example, the method 10, 20 may begin by providing a consent start date and a consent end date for the deposit transaction. The consumer may, for example, provide a consent start date for the deposit of the date on which the transaction is initiated. The consumer may be required to provide a consent end date for the deposit which is after the date on which the transaction is initiated, for example to allow the merchant time to request authorisation to complete the deposit transaction. On the same date, or on a later date, the method 10, 20 may then provide a consent start date and a consent end date for the remaining transaction. The consumer may, for example, provide the same consent start date and consent end date which is a deadline set by the merchant for providing the remainder of the payment.

In some embodiments, the transaction may comprise a data transaction, for example an exchange of data. In an example use case, a third party may wish to obtain data hosted by an issuer of a payment device, such as a physical payment card or a payment device comprising a digital wallet, held by the consumer. The consumer may be required to provide consent for the third party to obtain the date. For example, the third party may be a merchant from whom the consumer wishes to purchase age restricted goods, such as alcohol, and the data hosted by the issuer may relate to the age of the consumer. The merchant may need to access the age data of the consumer in order to verify that the consumer is old enough to purchase the goods. The merchant may provide a delivery date of age restricted goods to the consumer and the consumer may wish to limit the merchant's access to their age data such that the merchant is unable to access the consumer's personal data after delivery of the goods. The consumer may therefore provide a consent end date for accessing their age data which is the delivery date provided by the merchant.

Another example of an exchange of data that may be completed using either method 10, 20 comprises an exchange of payment data associated with the consumer. This may comprise tokenisation of the consumer's payment data, and/or registering the payment data with a secure payment service such as Mastercard Secure Remote Commerce (SRC). An exchange of payment data may also comprise linking a secure remote commerce (SRC) account, or similar, with a specific payment device.

In another example, a third party Open Banking application developer may wish to access transaction data, or other data, hosted by a payment network, for example the Mastercard® payment network. The data may be accessed through an application programming interface (API) hosted by a payment network, for example a Mastercard® API hosted by the Mastercard Digital Enablement Service (MDES).

As described above, in some embodiments the invention may provide a method of providing consent from a consumer to complete an action other than a payment transaction or a data transaction. In an example use case of such an embodiment, the action may comprise an update to terms and conditions of use of software. A consumer may purchase software from a software provider. The software provider may intend to update terms and conditions of use of the software at some point in the future before a specified date, but the exact date of the update may be unknown. In order to avoid sending a request for the consumer to consent to the updated terms and conditions on a day when the consumer may not be able to provide consent, the consumer can provide a consent start date and a consent end date for consent to any updates in terms and conditions. For example, the consent end date provided by the consumer may be the specified date before which the software provider intends to update the terms and conditions. This may also allow the software developer to carry out multiple updates to the terms and conditions before the specified date without the need for sending multiple requests for consent to the consumer.

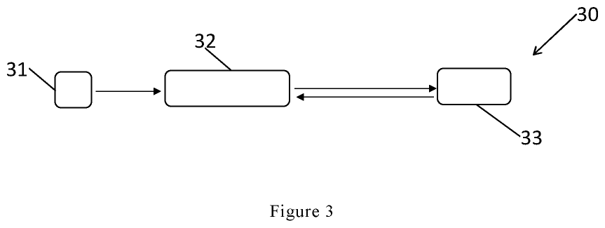

FIG. 3 shows a system 30, for completing a transaction, according to an embodiment. The system 30 may be used to implement the method 10 or the method 20 described above. The system 30 comprises a payment system 31, a merchant system 32 and an issuer system 33. The payment system 31 is configured to provide a consent start date from a consumer and a consent end date from the consumer. The merchant system 32 is configured to request authorisation to complete the transaction on a specified date. The issuer system 33 is configured to provide authorisation to complete the transaction if the specified date is after the consent start date and before the consent end date.

The payment system 31 is in communication with the merchant system 32, and the merchant system 32 and the issuer system 33 are in communication with one another. The arrows in FIG. 3 indicate the communication links between the payment system 31 and the merchant system 32, and the merchant system 32 and the issuer system 33. The communication links may be provided by a cloud system, a mobile network or any other suitable communications system.

In some embodiments, the payment system 31 may comprise any system configured to provide a consent start date from a consumer and a consent end date from the consumer. In some embodiments, the issuer system 33 may not be present. In some embodiments, the merchant system 32 may be any system configured to carry out any action which requires consent from a consumer. For example, the merchant system 32 may be configured to carry out an update to terms and conditions of use of software which requires consent from a consumer.

The system 30 may be further configured to authenticate the consent start date and/or the consent end date. The payment system 31 may comprise a payment device. The payment device may comprise a portable communications device comprising a digital device wallet configured to store a payment token. The system 30 may be configured to authenticate the consent start date and/or the consent end date using the payment token. For example, the merchant system 32 may be configured to authenticate the consent start date and/or the consent end date using the payment token.

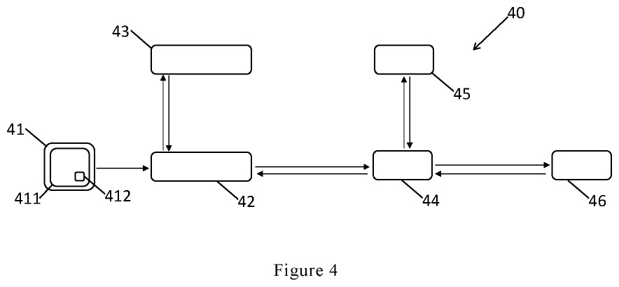

FIG. 4 shows a system 40 for completing a transaction according to an embodiment. The system 40 may be used to implement either of the methods 10, 20 described above. It will be appreciated that the system 40 is merely an example system according to an embodiment that could be used to implement either of the methods 10, 20 described above. Alternative systems according to other embodiments may be used to implement either of the methods 10, 20.

The system 40 comprises elements including: a payment system 41, a merchant system 42, a digital wallet 43, a payment network 44, a token service provider 45 and an issuer system 46. Each arrow shown in FIG. 40 represents a direction of communication between elements of the system 40. For example, the system 40 is configured with two-way communication between the merchant system 42 and the digital wallet 43. In the example of FIG. 4, one-way communication is provided from the payment system 41 and the merchant system 42. In some embodiments, two-way communication may be provided between payment system 41 and the merchant system 42, for example to facilitate refunds of payments. The communication links between the elements of the system 40 may be provided by a cloud system, a mobile network or any other suitable communications system.

In the example of FIG. 4, the payment system 41 comprises a payment device 411. The payment device 411 comprises a portable communications device comprising a digital device wallet 412. The digital device wallet 412 is configured to store a payment token, for example a payment token provided by the token service provider 45. In other examples, the payment device 411 may comprise a physical card, such as a credit card, debit card or prepaid card. In such examples, the digital device wallet 412, the digital wallet 43 and the token service provider 45 are not present.

The system 40 may be further configured to authenticate the consent start date and/or the consent end date. The system 40 may be configured to authenticate the consent start date and/or the consent end date using the payment token stored by the digital device wallet 412. For example, the merchant system 42 may be configured to authenticate the consent start date and/or the consent end date using the payment token.

In some examples, an acquirer system may be provided in communication with the merchant system 42 and the payment network 44. In some examples, the payment network 44 may comprise the Mastercard® payment network.

The digital wallet 43 may be hosted by a third party service such as Apple Pay®, Google Pay® or a Secure Remote Commerce (SRC) click-to-pay service.

The token service provider 45 may be part of the Mastercard Digital Enablement Service. In other examples, the payment network 44 acts as a token service provider and the separate token service provider 45 is not present.

In an example use case, the payment system 41 is operated by a cardholder, the merchant system 42 is operated by a merchant, and the issuer system 46 is operated by an issuer. The cardholder may be the consumer of either of the methods 10, 20 described above. In examples comprising an acquirer system, the acquirer system may be operated by an acquirer. In the example use case, a transaction is initiated by the cardholder. A payment token stored in the digital device wallet 412 is sent from the payment device 411 to the merchant system 42. A consent start date and a consent end date are provided by the cardholder.

The consent start date and consent end date may be provided by means of the payment device 411 as portable communications device. For example, the cardholder may initiate a transaction through a merchant website via the portable communications device. After initiating the transaction, a message may be sent to the cardholder via the portable communications device requesting the consent start date and/or the consent end date. The cardholder is then able to provide the consent start date and/or the consent end date. The consent start date and/or the consent end date may be authenticated, for example by the merchant system 42, using the payment token.

In other examples in which the payment device 411 comprises a physical card, the payment system 41 may further comprise a point-of-sale device. The consent start date and/or the consent end date may be requested and/or provided by means of the point-of-sale device. The consent start date and/or the consent end date may be authenticated, for example by the merchant system 42, using payment data associated with the physical card.

After receiving the payment token, the merchant requests payment credentials from the digital wallet 43. The payment token is sent from the merchant system 42 to the digital wallet 43. The payment token is then verified by the digital wallet 43. After verifying the payment token, a transaction cryptogram is generated by the digital wallet 43. In other examples, the transaction cryptogram is generated by the payment system 41. For example, the payment device 411 may comprise a secure element (SE) configured to generate the transaction cryptogram. In some examples, the payment device 411 may be configured to utilise a cloud based system, such as the Mastercard® Cloud Based Payments (MCBP) system, to generate the transaction cryptogram. In examples wherein the transaction cryptogram is generated by the payment system 41, the digital wallet 43 may not be present. In examples in which the payment device 411 comprises a physical card, the transaction cryptogram may be generated by an external server in place of the digital wallet 43. The external server may be in communication with a point-of-sale device of the payment system 41.

The transaction cryptogram comprises transaction information comprising the consent start date and the consent end date. The transaction information may further comprise the payment amount associated with the transaction, such as a maximum payment amount for which the cardholder provides their consent, and/or any other information required to complete the transaction. In some examples, the transaction cryptogram may comprise a digital signature. The digital signature may be generated using a private key or a symmetric key. The private or symmetric key may be held by the digital wallet 43, the payment system 41, for example by a secure element of the payment device 411, or by an external server in communication with a point-of-sale device. The transaction cryptogram may be digitally bound to a unique identifier associated with the merchant.

The transaction cryptogram is then sent from the digital wallet 43 to the merchant system 42. The payment token is returned to the merchant system 42 from the digital wallet 43 alongside the transaction cryptogram. The merchant system 42 may store a token unique reference of the payment token, for example in order to initiate future transactions. When the merchant wishes to complete the transaction, the merchant sends an authorisation request from the merchant system 42 to the payment network 44. The authorisation request comprises the transaction cryptogram and a specified date for completion of the transaction. In examples comprising an acquirer system, the authorisation request may be sent to the payment network 44 via the acquirer system. The payment network 44 then sends the transaction cryptogram to the token service provider 45. The token service provider 45 verifies the transaction cryptogram to validate the transaction information. In examples in which the transaction cryptogram comprises a digital signature generated using a private key, the signature is verified using a corresponding public key. The corresponding public key may be held by the token service provider 45. In examples in which the transaction cryptogram comprises a digital signature generated using a symmetric key, the transaction cryptogram is verified using the symmetric key shared with the token service provider 45.

In examples in which the payment network 44 acts as a token service provider, the transaction cryptogram may be verified by the payment network 44. In examples in which the transaction cryptogram comprises a digital signature generated using a private key, the corresponding public key may be held by the payment network 44. In examples in which the transaction cryptogram comprises a digital signature generated using a symmetric key, the symmetric key may be shared with the payment network 44.

Once the transaction cryptogram is verified, the transaction information is then sent to the payment network 44. The payment network 44 verifies the specified date of the authorisation request against the consent start date and the consent end date. If the specified date is the same as or later than the consent start date and the same as or earlier than the consent end date, the authorisation request is accepted and sent to the issuer system 46. The issuer system 46 then provides authorisation to complete the transaction. The authorisation is sent to the merchant system 42 via the payment network 44. In examples comprising an acquirer system, the authorisation may be sent to the merchant system 42 via the acquirer system.

If the specified date of the authorisation request is before the consent start date or after the consent end date, the payment network 44 does not verify the authorisation request. As a result, authorisation to complete the transaction may not be provided.

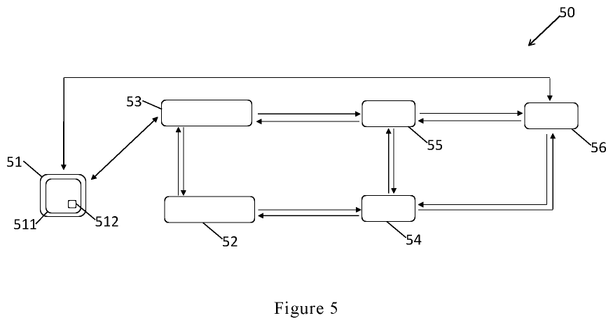

FIG. 5 shows a system 50, for completing a transaction, according to an embodiment. The system 50 may be used to implement either of the methods 10, 20 described above. It will be appreciated that the system 50 is merely an example system according to an embodiment that could be used to implement either of the methods 10, 20 described above. Alternative systems according to other embodiments may be used to implement either of the methods 10, 20.

The system 50 comprises elements including: a payment system 51, a merchant system 52, a digital wallet 53, a payment network 54, a token service provider 55 and an issuer system 56. Each arrow shown in FIG. 50 represents a direction of communication between elements of the system 50. For example, the system 50 is configured with two-way communication between the digital wallet 53 and the token service provider 55. The communication links between the elements of the system 50 may be provided by a cloud system, a mobile network or any other suitable communications system.

In the example of FIG. 5, the payment system 51 comprises a payment device 511. The payment device 511 comprises a portable communications device comprising a digital device wallet 512. The digital device wallet 512 is configured to store a payment token, for example a payment token provided by the token service provider 55. In other examples, the payment device 511 may comprise a physical card, such as a credit card, debit card or prepaid card. In such examples, the digital device wallet 512, the digital wallet 53 and the token service provider 55 are not present.

The system 50 may be further configured to authenticate the consent start date and/or the consent end date. The system 50 may be configured to authenticate the consent start date and/or the consent end date using the payment token stored by the digital device wallet 512. For example, the merchant system 52 may be configured to authenticate the consent start date and/or the consent end date using the payment token.

In the example of FIG. 5, the merchant system 52 is configured to store a token unique reference of a payment token. In some examples, an acquirer system may be provided in communication with the merchant system 52 and the payment network 54. In some examples, the payment network 54 may comprise the Mastercard® payment network.

The digital wallet 53 may be hosted by a third party service such as Apple Pay®, Google Pay® or a Secure Remote Commerce (SRC) click-to-pay service.

The token service provider 55 may be part of the Mastercard Digital Enablement Service. In other examples, the payment network 54 acts as a token service provider and the separate token service provider 55 is not present.

In an example use case, the payment system 51 is operated by a cardholder, the merchant system 52 is operated by a merchant, and the issuer system 56 is operated by an issuer. The cardholder may be the consumer of either of the methods 10, 20 described above. In examples comprising an acquirer system, the acquirer system may be operated by an acquirer. In the example use case, a transaction is initiated by the merchant. An example of a transaction that may be initiated by a merchant is a change in an amount of a regular subscription payment. The merchant system 52 stores a token unique reference of a payment token stored by the digital device wallet 512. The token unique reference may have been stored following a previous transaction between the cardholder and the merchant.

The merchant initiates the transaction by requesting consent from the cardholder to complete the transaction. In the embodiment of FIG. 5, this is achieved by sending a request for consent from the merchant system 52 to the digital wallet 53. The request for consent is sent along with the token unique reference stored by the merchant system 52. The request for consent is then sent from the digital wallet 53 to the token service provider 55. The request for consent is then sent from the token service provider 55 to the issuer system 56. The request for consent is then sent from the issuer system 56 to the payment system 51.

After the request for consent is sent to the payment system 51, a consent start date and a consent end date are requested from the cardholder. The consent start date and consent end date may be requested by means of the payment device 51 as a portable communications device. For example, a message may be sent to the cardholder via the portable communications device requesting the consent start date and/or the consent end date. In other examples in which the payment device 51 comprises a physical card, the consent start date and/or the consent end date may be requested and/or provided by means of a point-of-sale device.

After the cardholder has provided a consent start date and a consent end date, the consent start date and the consent end date are sent from the payment system 51 to the issuer system 56. The consent start and end dates are then sent from the issuer system 56 to the token service provider 55. The consent start and end dates are then sent from the token service provider 55 to the digital wallet 53.

A transaction cryptogram is then generated by the digital wallet 53. In other examples, the transaction cryptogram is generated by the payment device 51. For example, the payment device 511 may comprise a secure element (SE) configured to generate the transaction cryptogram. In some examples, the payment device 511 may be configured to utilise a cloud based system, such as the Mastercard® Cloud Based Payments (MCBP) system, to generate the transaction cryptogram. In examples wherein the transaction cryptogram is generated by the payment system 51, the digital wallet 53 may not be present. In examples in which the payment device 511 comprises a physical card, the transaction cryptogram may be generated by an external server, in place of the digital wallet 53. The external server may be in communication with a point-of-sale device of the payment system 51.

The transaction cryptogram comprises transaction information comprising the consent start date and the consent end date. The transaction information may further comprise a payment amount associated with the transaction, such as a maximum payment amount for which the cardholder provides their consent, and/or any other information required to complete the transaction. In some examples, the transaction cryptogram may comprise a digital signature. The digital signature may be generated using a private key or a symmetric key. The private or symmetric key may be held by the digital wallet 53, the payment device 511, for example by a secure element of the payment device 41, or by an external server in communication with a point-of-sale device. The transaction cryptogram may be digitally bound to a unique identifier associated with the merchant.

The transaction cryptogram is then sent from the digital wallet 53 to the merchant system 52. In examples wherein the transaction cryptogram is generated by the payment device 511, the consent start and end dates may not be sent from the payment system 51 to the issuer system 56 and on to the digital wallet 53 as described above. The transaction cryptogram may be sent directly from the payment device 51 to the digital wallet 53, or directly from the payment device 51 to the merchant system 52.

The payment token is returned to the merchant system 52 from the digital wallet 53 alongside the transaction cryptogram. When the merchant wishes to complete the transaction, the merchant sends an authorisation request from the merchant system 52 to the payment network 54. The authorisation request comprises the transaction cryptogram and a specified date for completion of the transaction. In this example, the specified date is the date on which the merchant sends the authorisation request. In other examples, the specified date may be a date later than the date on which the merchant sends the authorisation request. In examples comprising an acquirer system, the authorisation request may be sent to the payment network 54 via the acquirer system. The payment network 54 then sends the transaction cryptogram to the token service provider 55. In examples in which the transaction cryptogram comprises a digital signature generated using a private key, the transaction cryptogram is verified using a corresponding public key. The corresponding public key may be held by the token service provider 55. In examples in which the transaction cryptogram comprises a digital signature generated using a symmetric key, the transaction cryptogram is verified using the symmetric key shared with the token service provider 55.

In examples in which the payment network 54 acts as a token service provider, the transaction cryptogram may be verified by the payment network 54. In examples in which the transaction cryptogram comprises a digital signature generated using a private key, the corresponding public key may be held by the payment network 54.

Once the transaction cryptogram is verified, the transaction information is then sent to the payment network 54. The payment network 54 verifies the specified date against the consent start date and the consent end date. If the specified date is the same as or later than the consent start date and the same as or earlier than the consent end date, the authorisation request is accepted and sent to the issuer system 56. The issuer system 56 then provides authorisation to complete the transaction. The authorisation is sent to the merchant system 52 via the payment network 54. In examples comprising an acquirer system, the authorisation may be sent to the merchant system 52 via the acquirer system.

If the specified date, i.e. the date of the authorisation request in this example, is before the consent start date or after the consent end date, the payment network 54 does not accept the authorisation request. As a result, authorisation to complete the transaction may not be provided.

Although the systems 40, 50 have been described above with respect to a single payment transaction, it will be appreciated the systems 40, 50 may also be used to complete multiple payment transactions. For example, either of the systems 40, 50 may be used to complete multiple payment transactions as described above with reference to the method 10. The systems 40, 50 may also be used to complete data transactions, for example as described above with reference to the method 10.

The merchant systems, acquirer systems and/or issuer systems described above may comprise one or more processors, servers and other computational equipment hosted by a merchant, and acquirer and an issuer respectively.

Table 1 below illustrates an example of how existing data elements which may be used to complete a conventional transaction, i.e. wherein consent to complete the transaction is provided at the time the transaction is initiated, can be modified to implement a method according to the invention. These data elements are conventionally sourced by a merchant in order to complete a transaction.

TABLE 1

| | Size | | |
|---|---|---|---|
| Data element | (bytes) | Format | Modification |
| Amount, Authorized | 6 | n12 | Max. Amount for the future |
| (Numeric) | | | transaction(s) |
| Amount, Other | 6 | n12 | Acceptable period for the |
| (Numeric) | | | future transaction(s): |
| | | | Start date YYMMDD (3 bytes) ∥ |
| | | | End date YYMMDD (3 bytes) |
| Terminal Country | 2 | n4 | Local Time (HH:MM) at which |
| Code | | | the consent was given (consent |
| | | | timestamping) |
| Terminal | 1 | Hex | byte 1-4: Merchant Identifier |
| Verification | | | hash |
| Results | | | byte 5: Max number of future |
| | | | transactions |
| Transaction | 2 | n3 | Currency of the future |
| Currency | | | transaction(s) |
| Code | | | |
| Transaction Date | 3 | n6 | Local Date (YYMMDD) at |
| | | | which the consent was given |
| | | | (consent timestamping) |
| Transaction Type | 1 | Hex | SPECIFIC PROPRIETARY |
| | | | transaction type, identifying |
| | | | a consent |
| Unpredictable | 4 | Hex | Merchant Unpredictable Number |
| Number | | | |

In the example of Table 1, a data element conventionally used to represent a payment amount of a given transaction has been modified to represent a maximum payment amount that a consumer may provide consent for. The data element ‘Amount, Other (Numeric)’ has been modified to represent the consent start date and the consent end date of the invention. The local time and date at which the consumer provided the consent start and end dates, represented by the ‘Terminal Country Code’ and ‘Transaction Date’ data elements respectively, may be transmitted to the consumer in case the consumer attempts to rescind their consent at the time of completion of the transaction. The ‘Transaction Type’ data element is used to indicate that the consent provided for by the consumer is for a future transaction, i.e. a transaction to be completed after the transaction is initiated.

1. A computer implemented method of completing a transaction, the method comprising:
providing a consent start date from a consumer;
providing a consent end date from the consumer;
requesting authorisation to complete the transaction on a specified date; and
providing authorisation to complete the transaction if the specified date is the same as or later than the consent start date and the same as or earlier than the consent end date.

2. The method of claim 1, comprising generating a cryptogram comprising the consent start date and the consent end date.

3. The method of claim 1, comprising generating a cryptogram comprising the date and/or time the consent start date and/or the consent end date is provided from the consumer.

4. The method of claim 2, wherein the or each cryptogram forms part of authentication data for communication in a 3D-Secure protocol.

5. The method of claim 2, wherein the or each cryptogram forms part of a transaction authorisation message or a financial request message.

6. The method of claim 2, wherein the or each cryptogram is generated by a digital wallet.

7. The method of claim 2, wherein the or each cryptogram is generated by a payment device.

8. The method of claim 1, comprising digitally signing the consent start date and the consent end date.

9. The method of claim 1, comprising digitally signing the date and/or time the consent start date and/or the consent end date is provided from the consumer.

10. The method of claim 1, comprising providing a consent start date and a consent end date for multiple transactions.

11. The method of claim 1, wherein the transaction comprises an exchange of data.

12. The method of claim 11, wherein the exchange of data comprises an exchange of personal data relating to the consumer.

13. The method of claim 11, wherein the data exchange comprises an exchange of payment data associated with the consumer.

14. The method of claim 1, wherein the transaction is initiated by a merchant.

15. A system for completing a computer implemented transaction, the system comprising:
a payment system configured to: provide a consent start date from a consumer, and provide a consent end date from the consumer;
a merchant system configured to request authorisation to complete the transaction on a specified date; and
an issuer system configured to provide authorisation to complete the transaction if the specified date is after the consent start date and before the consent end date.

16. The system of claim 15, comprising a payment network in communication with the merchant system and the issuer system.

17. The system of claim 15, wherein the payment system comprises a portable communications device comprising a digital device wallet.

18. The system of claim 15, comprising a digital wallet in communication with the merchant system.

19. The system of claim 15, comprising a token service provider.

20. The method of claim 17, wherein the portable communications device generates a cryptogram comprising the consent start date and the consent end date.
